(19) United States
(12) Patent Application Publication
(10) Pub. No.: US 2008/0172450 A1
(43) Pub. Date: Jul. 17, 2008

(54) Mobile service apparatus

(75) Inventors: Jung-Shia Wu, Taipei County (TW); Te-Lien Lo, Taipei County (TW)

Correspondence Address: BROWDY AND NEIMARK, P.L.L.C.;624 NINTH STREET, NW, SUITE 300, WASHINGTON, DC, 20001-5303, US

(73) Assignee: An Chen Computer Co., Ltd., Banciao City (TW)

(21) Appl. No.: 11/717,087

(22) Filed: Mar. 13, 2007

(30) Foreign Application Priority Data
Jan. 12, 2007 (TW) 96101353

(51) Int. Cl. G06F 15/16

(52) U.S. Cl. 709/203

(57) ABSTRACT

A mobile service apparatus includes a repository server and a mobile client. The repository server includes stores various programs and data therein. The mobile client is a portable device to be operated by user. The mobile client may be connected to the repository server to download predetermined programs and data stored in the repository server. The mobile service apparatus provides the function of changing the program executed in the mobile client by connecting the mobile client and the repository server to download the specific programs and data stored in the repository server so that the mobile client becomes a portable special purposed device for execution of the programs after the mobile client is separated from the repository server.

### BACKGROUND OF THE INVENTION

1. Field of the Invention

The present invention relates to a consumer electronic device, and more particularly to a mobile service apparatus, which may switch the service functions installed therein.

2. Description of the Related Art

The minimum in size of the transistors and electric circuits in an integrated circuit creates the age of information and electronic commerce. The integrated circuits are broadly incorporated in many fields, such as computers, programmable machines, consumer electronic products, telecommunications and networks, wireless networks and communications, industrial automatic systems and medical equipments. The electronic products are required to have functions of easy to operate, mass access, more features and meeting of requirements of consumers and customers. The integrated circuit technique is developing in a very fast speed.

Personal computer is a common electronic product, which have powerful computation and mass storage capacity to execute various application programs. The main reason why personal computer has not been incorporated in mobile service is its size and weight. Notebook is a portable computer with small size and light weight. Notebook has computing power similar to personal computer, and the major problem is the capacity of battery, which may not provide enough working time yet. Beside that the present notebooks still can be lighter and smaller to achieve the exact function of “mobile”.

To approach mobile service, some special purposed devices, such as personal digital assistant (PDA), electronic translation device, satellite navigation device, and so on, are provided in market. Theses special purposed devices only provide single or a few functions for execution so that these kinds of devices are designed with smaller size, lighter weight and longer running time.

The present special purposed devices have build-in programs when they are made in factory and they are unalterable so that user has to pay a lot for the special purposed devices with various functions that is not good for consumers.

### SUMMARY OF THE INVENTION

The primary objective of the present invention is to provide a mobile service apparatus, which may change the functions thereof according to user's desire.

According to the objective of the present invention, a mobile service apparatus includes a repository server and a mobile client. The repository server includes stores various programs and data therein. The mobile client is a portable device to be operated by user. The mobile client may be connected to the repository server to download predetermined programs and data stored in the repository server so that the mobile client becomes a portable special purposed device for execution of the programs after the mobile client is separated from the repository server.

### BRIEF DESCRIPTION OF THE DRAWINGS

FIG. 1 is a sketch diagram of a preferred embodiment of the present invention;

FIG. 2 is a block diagram of the repository server of the preferred embodiment of the present invention;

FIG. 3 is a block diagram of the mobile client the preferred embodiment of the present invention;

FIG. 4 is a sketch diagram of the preferred embodiment of the present invention, showing the mobile client connected to the repository server to download or upload programs or files; and

FIG. 5 is a sketch diagram of the preferred embodiment of the present invention, showing mobile client being a duplicator after download relative program from the repository server and duplicating data from a computer to a SD memory card.

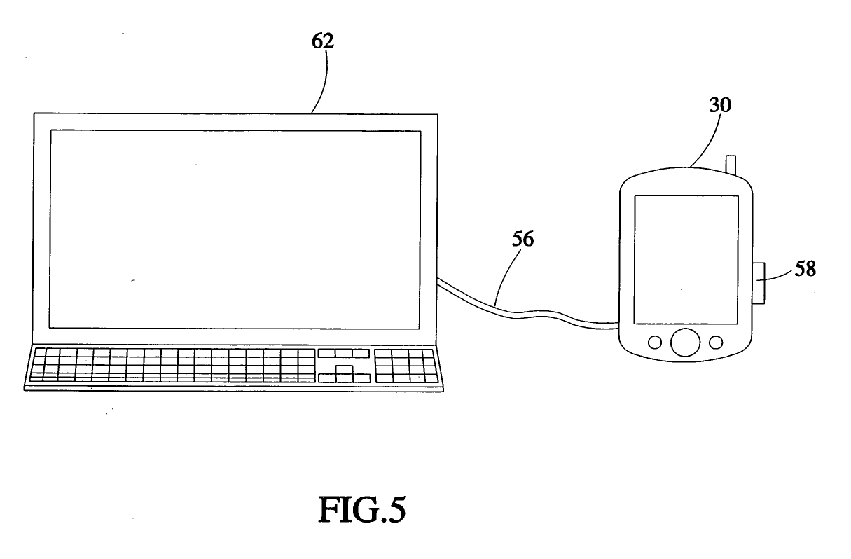

### DETAILED DESCRIPTION OF THE INVENTION

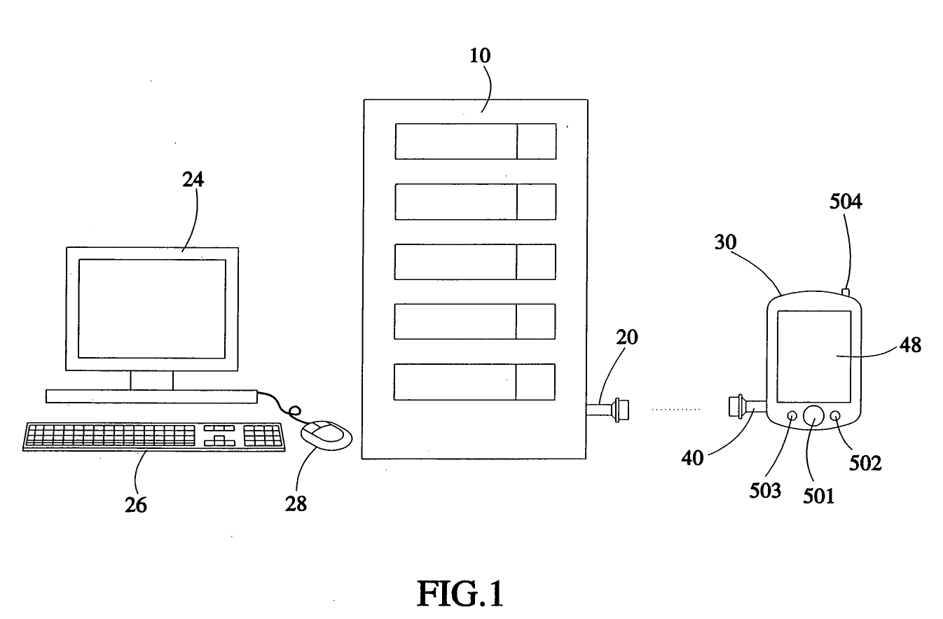

As shown in FIG. 1 to FIG. 3, a mobile service apparatus of the preferred embodiment of the present invention includes a repository server 10 and a mobile client 30.

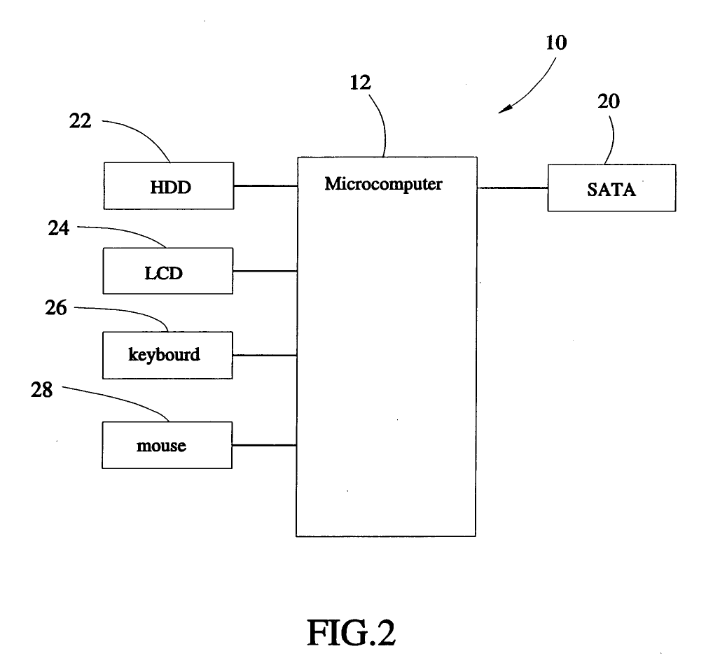

As shown in FIG. 2, the repository server 10 includes a build-in micro processing system 12, which includes a central processing unit, a flash memory and dynamic random access memory (DRAM) (not shown), an input/output (I/O) device 20, a storage device 22, a display 24 and an operating device including a keyboard 26 and a mouse 28. The micro-processing system 12 is the main control system of the repository server 10. The flash memory 16 stores core programs. The storage device 22 is a hard disk drive with SATA interface, in which system programs and various application programs are stored. The I/O device 20, which is a SATA interface (serial ATA interface), is connected to the storage device 22. The repository server 10 basically is as same as a conventional personal computer so we do not discuss the detail here.

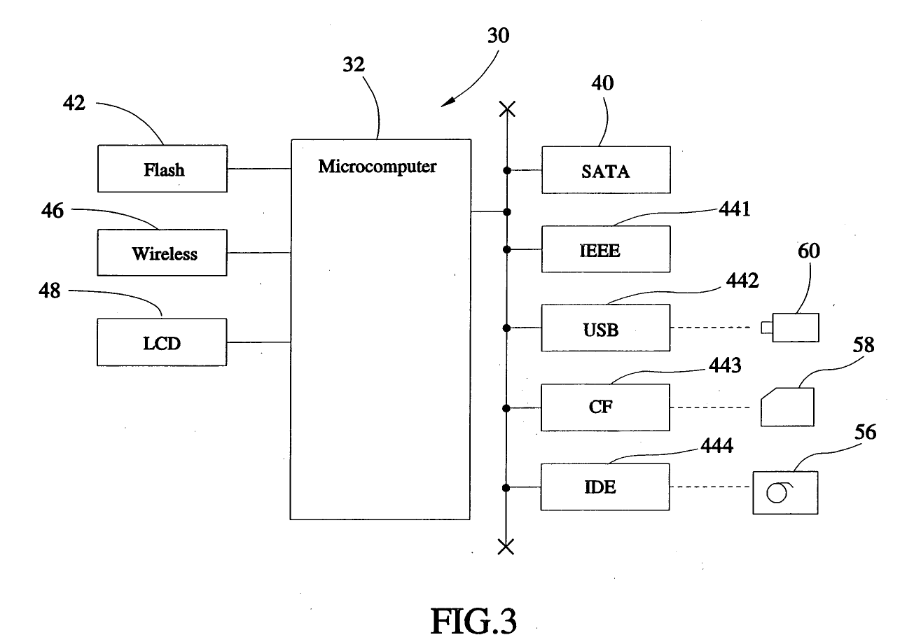

As sown in FIG. 3, the mobile client 30 includes a build-in micro processing system 32, which includes a CPU, a flash memory, a RAM (not shown), an I/O device 40, a storage device 42, a plurality of connecting devices 441˜444, a wireless transmission module 46, a display 48, a plurality of keys 501˜504 and a power (not shown). The CPU, flash memory and RAM are as same as that of a conventional computer or consumer electronic product. The connecting devices 441˜444 are various interfaces, such as IEEE 441, USB 442, SATA, ATA, CF 443, and IDE 44 or other relative interfaces, to connect various storage devices, such as hard disk drive 56, floppy disk drive, memory card 58, flash drive 60, or other relative storage devices. The connecting devices also may connect the mobile client 30 to a computer 62 to access data. The main character of the present invention is that the mobile client 30 may be connected to the repository server 10 through the connection of the I/O devices 20 and 40 to transfer data or programs therebetween. In other words, the mobile client 30 may be transferred with predetermined data or programs from the repository server 10 to change the mobile client 30 into a special purposed device for execution of the programs.

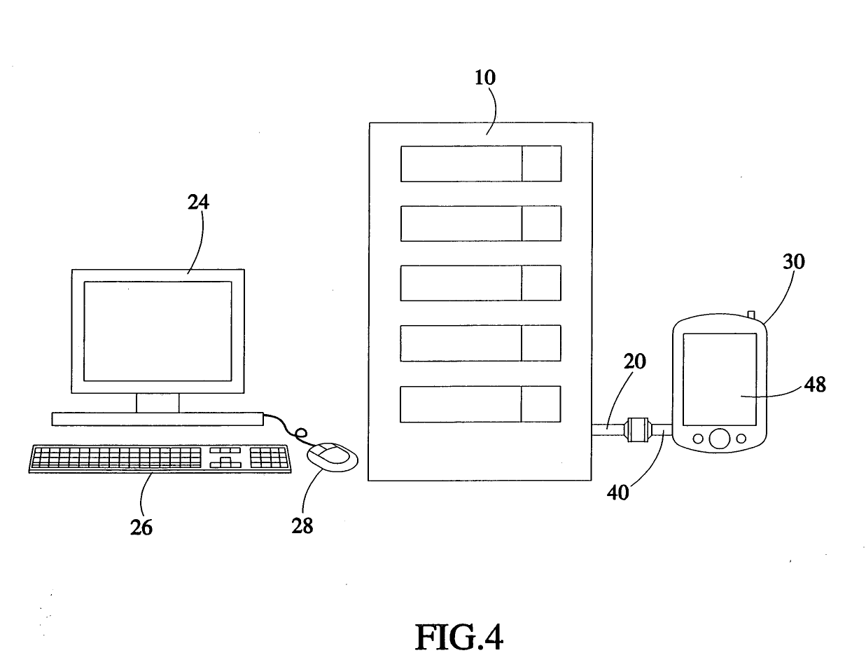

For example, if a user needs duplicating function apparatus, as shown in FIG. 4, he/she has to connect the mobile client 30 to the repository server 10 and download the duplicating relative programs and data from the storage device 22 of the repository server 10. As a result, the mobile client 30 now becomes a duplicator. After that, user may be connected to a source storage device (it is a computer 62 shown in FIG. 4) through a cable 54, and a target storage device is connected to the mobile client 30 (it is a SD memory card 58 inserted into the very socket of the mobile client 30 shown in FIG. 4). Therefore, user may operate the keys 501˜504 of the mobile client 30 for duplication of data from the computer 62 to the SD memory card 58. The mobile client 30 may be connected to the repository server 10 to copy the data in the SD memory card 58 to the repository server 10.

For the same principle, the mobile client 30 may be a translation machine when it is connected to the repository server 10 and downloads the relative programs and data of translation from the storage device 22 of the repository server 10.

For different programs being executed in the mobile client 30 respectively, the mobile client 30 should have various operation interfaces for user to operate the mobile client 30. The present invention provides the display 48 of the mobile client 30 a touch panel LCD, which may provide various images on screen for user to operate different programs in the same mobile client 30. The keys 501˜504 are designed as general control keys, such as arrow keys 501, Enter 502, Esc 503 and power 504. Touch pen (not shown) is a considerable input device equipped in the mobile client 30 of the present invention to operate the touch panel LCD 48. The mobile client 30 of the present invention also may be equipped with a microphone (not shown) to provide the mobile client 30 with audio input function.

Except for the translation and duplication functions, the mobile service apparatus of the present invention may provides more services, such as audio book, system package, data package, file package, database package, auto category, package transfer, navigation for travel, map navigation, and so on.

In the embodiment, the SATA is the data transferring interface between the mobile client 30 and the repository server 10. In practice, any data transferring interface may be incorporated in the present invention, even the wireless technique or Bluetooth technique.

In conclusion, the present invention provides the repository server 10 storing various application programs and data therein, and the portable mobile client 30 may be connected to the repository server 10 to download or upload one or more programs and(or) data that the mobile client 30 may change itself to a portable special proposed machine to execute the program after the mobile client 30 is separated from the repository server 10. If a new service function has present to market, user only has to but the software and store it in the repository server 10 so that the mobile client 30 may download the program to become the special proposed machine of the new service function. In addition, one repository server 10 may serve a plurality of mobile clients 30.

The description above is a preferred embodiment of the present invention and the equivalence of the present invention is still in the scope of the claim of the present invention.

What is claimed is:

1. A mobile service apparatus, comprising:
a repository server including a micro processing system, a storage device and an input/output device, wherein the storage device stores programs and data therein; and
a mobile client, which is a portable device, including a micro processing system, a display, an input/output device and a power, wherein the mobile client may be connected to the repository server through the input/output device of the mobile client and the input/output device of the repository server to download predetermined programs and data stored in the storage device of the repository server and store them in the storage device of the mobile client so that the mobile client becomes a portable special purposed device for execution of the programs after the mobile client is separated from the repository server.

2. The mobile service apparatus as defined in claim 1, wherein the storage device of the mobile client and the input/output device of the repository server are selected from the group consisting of IEEE interface, ATA interface, SATA interface, USB interface and CF interface.

3. The mobile service apparatus as defined in claim 1, wherein the storage device of the mobile client and the input/output device of the repository server are wireless transmission device or Bluetooth device.

4. The mobile service apparatus as defined in claim 1, wherein the display of the service client includes a touch panel.

5. The mobile service apparatus as defined in claim 1, wherein the service client further includes a microphone for audio input.

6. The mobile service apparatus as defined in claim 1, wherein the service client further includes at least a connecting device for connection with other storage device or computer.

7. The mobile service apparatus as defined in claim 6, wherein the connecting device of the service client is selected from the group consisting of IEEE interface, ATA interface, SATA interface, USB interface and CF interface.

8. The mobile service apparatus as defined in claim 1, wherein the service client further includes a wireless transmission module.

9. The mobile service apparatus as defined in claim 1, wherein the service client further includes a plurality of keys for operation by user.

10. The mobile service apparatus as defined in claim 9, wherein the keys of the service client includes a Enter key, a Esc key, arrow keys and a power key.
